(19) United States
(12) Patent Application Publication
(10) Pub. No.: US 2025/0244551 A1
(43) Pub. Date: Jul. 31, 2025

(54) MULTI-SPOOL CABLE REEL

(71) Applicant: viaPhoton, Inc., Aurora, IL (US)

(72) Inventors: Mark James SMRHA, Chicago, IL (US); Yihan ZHANG, Aurora, IL (US); Walter Mark HENDRIX, Dallas, TX (US); Mark VAN DEN AVONT, Arlington Heighs, IL (US)

(21) Appl. No.: 19/040,388

(22) Filed: Jan. 29, 2025

Related U.S. Application Data
(60) Provisional application No. 63/626,504, filed on Jan. 29, 2024.
(60) Provisional application No. 63/698,391, filed on Sep. 24, 2024.

(51) Int. Cl. G02B 6/44; B65H 49/32; B65H 75/28

(52) U.S. Cl. CPC G02B 6/4457; B65H 49/32; B65H 75/28; B65H 2402/60; B65H 2701/32

(57) ABSTRACT

In general, in one aspect, one or more examples relate to apparatuses and methods for deploying a cable. The apparatuses comprises a set of spools. Each spool includes a pair of flanges, and a cable hub positioned between them. The cable hub defines one or more module compartments configured to house modules. A cable is wound around the hub, with at least one module contained within the module compartments and connected to a first end of the cable.

### CROSS-REFERENCE TO RELATED APPLICATIONS

This application claims the benefit of U.S. Provisional Application Ser. No. 63/626,504, filed Jan. 29, 2024, which is incorporated by reference herein. This application claims the benefit of U.S. Provisional Application Ser. No. 63/698,391, filed Sep. 24, 2024, which is incorporated by reference herein.

### BACKGROUND

In environments such as data centers, cable routing systems often require connections between multiple racks or devices. To facilitate these connections, cables are stored on reels for storing, transporting, and deploying cables in an organized manner. These reels typically consist of a central hub with flanges to contain the coiled cable, ensuring the cable remains secure during handling and transportation. Conventional reels are designed for single-cable applications, where one cable is wrapped around a single hub and unspooled during deployment.

Traditional single-spool cable reels may not be well-suited for applications involving multiple endpoints, as they often necessitate the use of multiple reels or manual redistribution of cables. This approach can lead to increased storage needs, additional handling steps, and higher installation times, particularly in scenarios involving significant cable lengths or complex routing paths. Traditional reels may not allow independent control of multiple cables, which can result in issues such as tangled lines, uneven tension during payout, or limitations in routing flexibility.

### SUMMARY

In general, in one aspect, one or more examples relate to an apparatus comprising a set of spools. Each spool includes a pair of flanges, and a cable hub positioned between them. The cable hub defines one or more module compartments configured to house modules. A cable is wound around the hub, with at least one module contained within the module compartments and connected to a first end of the cable.

In one aspect, one or more examples relate to a method for deploying a cable. A spool is provided at a first location. The spool comprises a pair of flanges; and a cable hub juxtaposed between the pair of flanges. One or more module compartments are positioned within the cable hub; and configured to contain one or more modules a pair of flanges. A cable is wound around the cable hub. The cable has a first module attached to a first end of the cable, first module contained within the one or more module compartments of the spool. The cable is unwound from the cable hub to deploy a second end of the cable to a second location. the first module removed from the one or more module compartments; and connected to network equipment at the first location.

Other aspects of the invention will be apparent from the following description and the appended claims.

### BRIEF DESCRIPTION OF DRAWINGS

FIG. 1 is a rack, shown in accordance with one or more embodiments.

FIGS. 2A and 2B show a multi-spool cable reel according to illustrative embodiments.

FIGS. 3A and 3B is a single spool showing details of the cable hub, shown according to illustrative embodiments.

FIGS. 4A and 4B is a spool shown, according to illustrative embodiments.

FIGS. 5A and 5B is a single spool showing details of the cable hub according to illustrative embodiments.

FIGS. 6A and 6B show a cover flange according to illustrative embodiments.

FIG. 7 shows a method for deploying a cable, according to illustrative embodiments.

Like elements in the various figures are denoted by like reference numerals for consistency.

### DETAILED DESCRIPTION

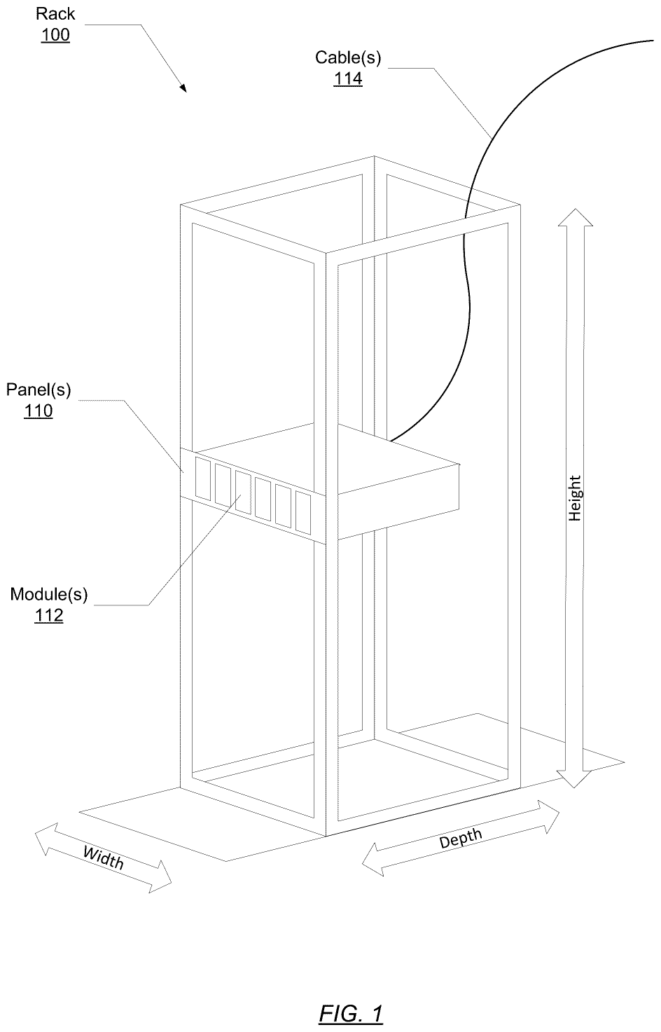

Turning to FIG. 1, a rack is shown in accordance with one or more embodiments. The rack (100) is a piece of telecommunications equipment that provides for the housing and organization of diverse telecommunication devices.

The outer dimensions of rack (100) align most network and server equipment. For example, rack width may measure 19 inches (48.26 cm) or 23 inches (58.42 cm) in width, standard measurements that are adhered to in the telecommunications industry. Other dimensions may be used, e.g., 21 inches, 23 inches, etc. The dimensions ensure that the rack can accommodate equipment with different form factors, such as 1 U, 2 U, or larger units, where “U” represents a standard rack unit of measure equal to 1.75 inches in height.

The rack (100) may include a series of uniformly spaced vertical mounting slots, located on both the front and rear, to facilitate the arrangement and mounting of various telecommunication devices and components. The slots serve as attachment points for mounting the panel(s) (110). The rack (100) may further be equipped with additional features such as ventilation openings and cable management.

Panel(s) (110) are components that mount within the rack (100) to organize, secure, and provide access to connective hardware. The panel may be constructed from materials like steel or aluminum that can support the weight of the modules and withstand the physical demands of a data center environment.

Panel(s) (110) are formed with standardized form factors for compatibility with the mounting slots of the rack (100). For example, panel(s) (110) may include standardized mounting points to align with rack units, a layout that supports the intended cable or connector density, and provisions for labeling and user accessibility.

The panel(s) (110) may be equipped with one or more module(s) (112) to secure the fibers using ports, connector adapters, connectors, etc. Module(s) (112) are prefabricated units or sub-assemblies designed for quick installation into the rack (100). The module(s) (112) may include electronic components and/or optical components, such as optical connectors, optical fibers, switches, routers, or patches. The module(s) (112) may include features for splicing, cable management, and security.

Each module(s) (112) is designed to contain a specific number of optical connectors, optimizing space utilization within the rack mount to support high fiber densities. The connectors may be an industry-standard connector such as a standard connector (SC), Lucent connector (LC), or Multi-fiber Termination Push-on connector (MTP), depending on the network requirements. For example, each module(s) (112) may support fiber densities of 144 fibers per module, 288 fibers per module, and/or 576 fibers per module, as well as other suitable densities.

The module(s) (112) may have multiple widths, such that a varying number of modules may be housed within the panel(s) (110). The module(s) (112) is sized to fit twelve (12) modules in the panel(s) (110), however other sizes—e.g., 2, 3, 4, 6, 8—are also contemplated.

The modules can be interconnected via cable(s) (114). Cable(s) (114) may be fiber optic cables that carry data signals between different network devices and components. Cable(s) (114) are routed through the data center infrastructure, connecting panels, modules, and external devices. These cables may include a core, cladding, and protective coating, which ensure the integrity of the data signal. The cables may be color-coded to facilitate identification during installation and maintenance. Cable(s) (114) can be single-mode or multi-mode, depending on the network requirements.

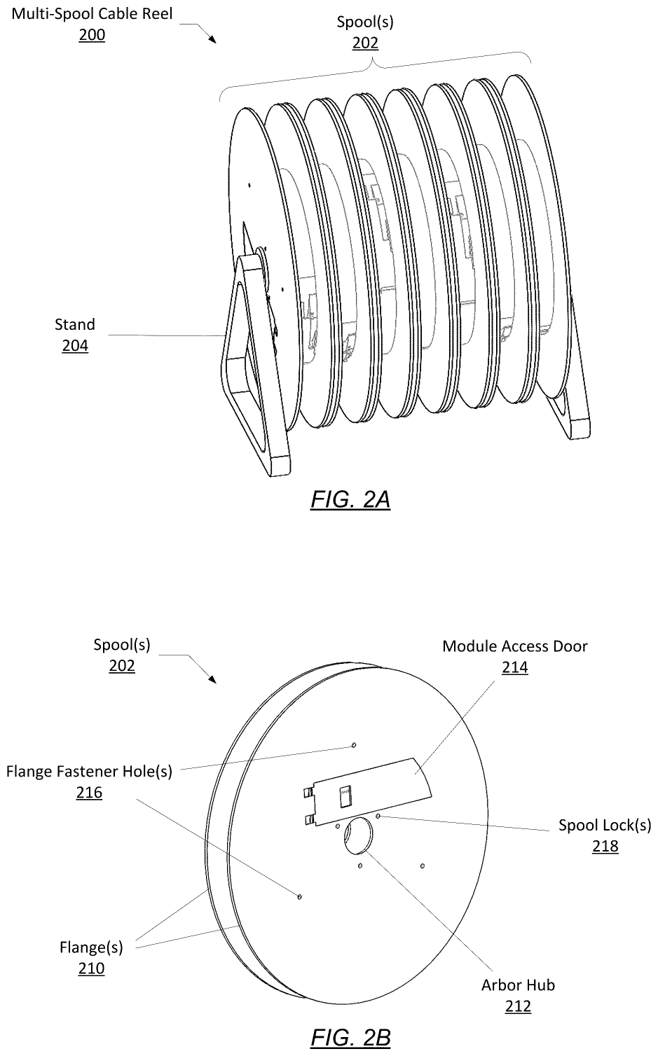

FIG. 2A shows a multi-spool cable reel according to illustrative embodiments.

The multi-spool cable reel (200) comprises a set of spools (202) arranged in parallel and mounted on a stand (204). Each spool includes a central cable hub surrounded by a pair of flanges that provide structural containment for the cable wound around the hub. The spools are positioned on a central axis, allowing rotation to facilitate the payout or retrieval of cables stored on each hub.

The stand (204) supports the set of spools (202) and provides a stable base for the system. The spools are spaced apart by interposed spacers to minimize friction and allow independent rotation of each spool. Each spool is designed with features to accommodate modular components, such as module compartments within the hub, for storing adapter modules or other related elements. Access to these compartments is facilitated by access doors integrated into the structure of at least one flange.

FIG. 2B shows a spool for a multi-spool cable reel according to illustrative embodiments.

The spool (202) depicted comprises a pair of flanges (210) positioned on either side of a central cable hub. The flanges include flange fastener holes (216) for securing the flanges to the central hub. These fastener holes enable the attachment of structural components and contribute to the stability of the spool assembly.

A module access door (214) is integrated into one of the flanges and provides access to one or more module compartments located within the central hub. The module access door is configured to allow insertion, inspection, or removal of modules housed within the hub. The radius of curvature of the access door aligns with the curvature of the flange to maintain the cylindrical form of the spool when closed.

An arbor hub (212) is centrally positioned within the cable hub to allow for rotational mounting of the spool. This arbor hub interacts with a central rod or axle, enabling the spool to rotate during cable winding or unwinding operations. The spool also includes spool locks (218), which are designed to secure the spool in place or facilitate the co-rotation of multiple spools on a shared axle.

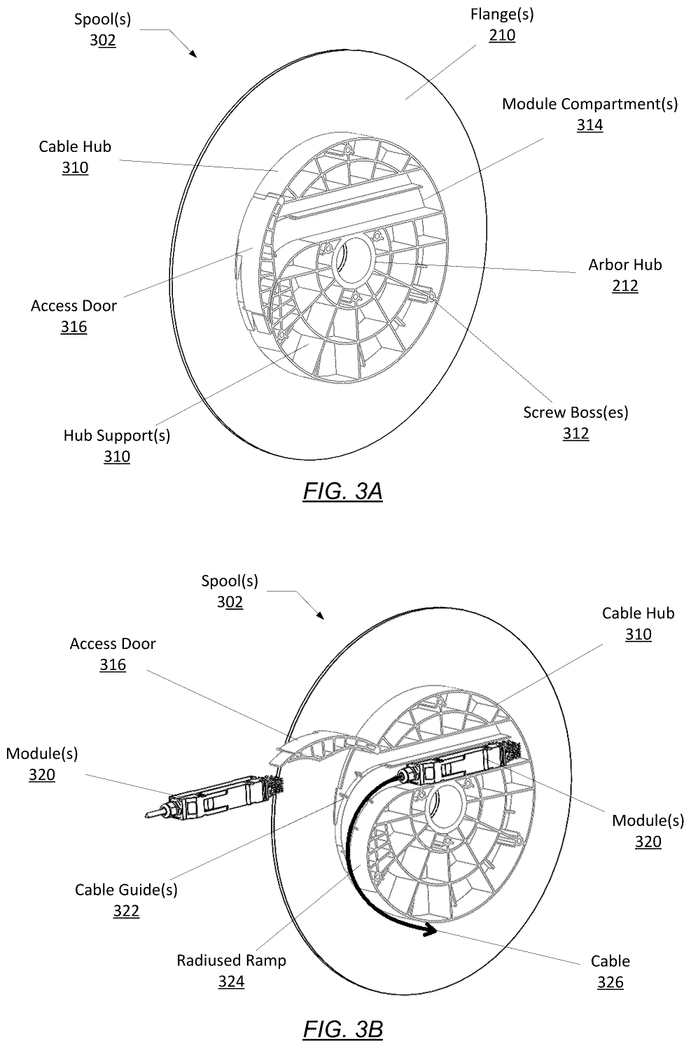

Referring now to FIGS. 3A and 3B, a single spool showing details of the cable hub is shown according to illustrative embodiments.

The spool (302) includes a cable hub (310) positioned between a pair of flanges (210). The cable hub comprises module compartments (314) integrated within its structure, which are configured to house modules, such as adapter modules or similar components. An access door (316) is positioned on the hub and provides selective access to the module compartments, allowing for the insertion, removal, or inspection of the contained modules. The access door's design aligns with the outer curvature of the cable hub to maintain a continuous surface when closed.

The arbor hub (212) is centrally located within the cable hub and is designed to interface with an axle or rod, enabling the spool to rotate. The arbor hub facilitates the winding and unwinding of cables stored on the spool. Screw bosses (312) are distributed around the structure of the cable hub and are configured to receive fasteners that secure various components of the spool assembly, including the flanges.

Hub supports (310) extend radially within the cable hub and provide structural reinforcement to maintain the integrity of the hub under rotational stress. These supports connect the arbor hub to the outer regions of the cable hub and ensure even distribution of mechanical forces.

Referring specifically to FIG. 3B, the spool (302) comprises a cable hub (310) positioned between flanges, with module compartments designed to house one or more modules (320). An access door (316) is positioned on the hub, providing entry to the module compartments for inserting or removing modules. The modules are configured to interface with cables that route through the spool system.

Cables (326) exit the module compartments through a cable guide (322) that directs the cable along a defined path. The cable guide is positioned to align with a radiused ramp (324) that transitions the cable from the interior of the hub to its exterior. This configuration maintains the bend radius of the cable and minimizes stress during routing.

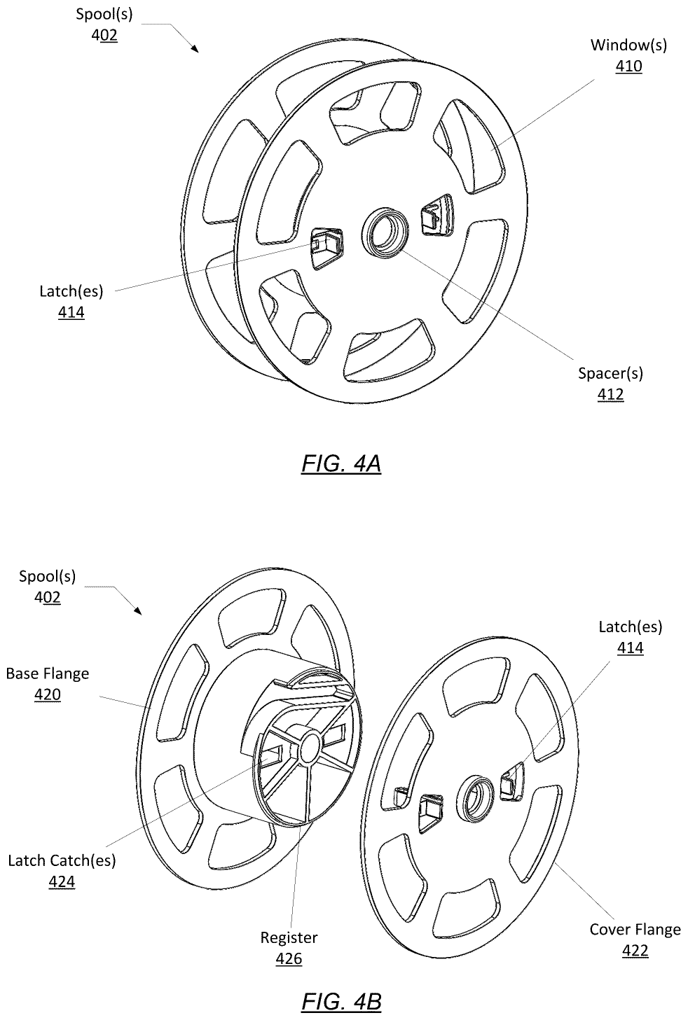

Referring now to FIGS. 4A and 4B, a spool is shown according to illustrative embodiments.

The spool (402) includes a central hub with a pair of flanges, each incorporating multiple windows (410) that reduce the material weight and provide visibility into the interior structure of the spool. The central hub is configured to receive an axle or rod to facilitate rotational movement of the spool during cable management operations.

Spacers (412) are positioned on the hub and extend axially to create separation between adjacent spools when assembled in a multi-spool configuration. These spacers allow for independent or co-rotational operation of the spools by minimizing friction and ensuring proper alignment.

Latches (414) are integrated into the spool design to enable assembly and disassembly of spools within a multi-spool system. The latches are configured to lock into corresponding features on adjacent spools, facilitating modular and secure attachment.

As shown in FIG. 4B, the spool (402) comprises a base flange (420) and a cover flange (422), which together enclose a cable hub. The base flange and cover flange are configured to interlock using latch(es) (414) located on the cover flange. These latches engage with corresponding latch catches (424) on the base flange to secure the assembly. The latches and latch catches facilitate easy assembly and disassembly of the spool components.

A cable hub is positioned between the base and cover flanges, includes a register (426) along its outer diameter. The register aligns the base flange with the cover flange during assembly, ensuring proper positioning and structural integrity. In some embodiments, the cable hub may be monolithic with one or more of the flanges, such as the base flange or the cover flange. The hub may also include internal structural features to support the spool and maintain alignment under load when cables are wound around the cable hub.

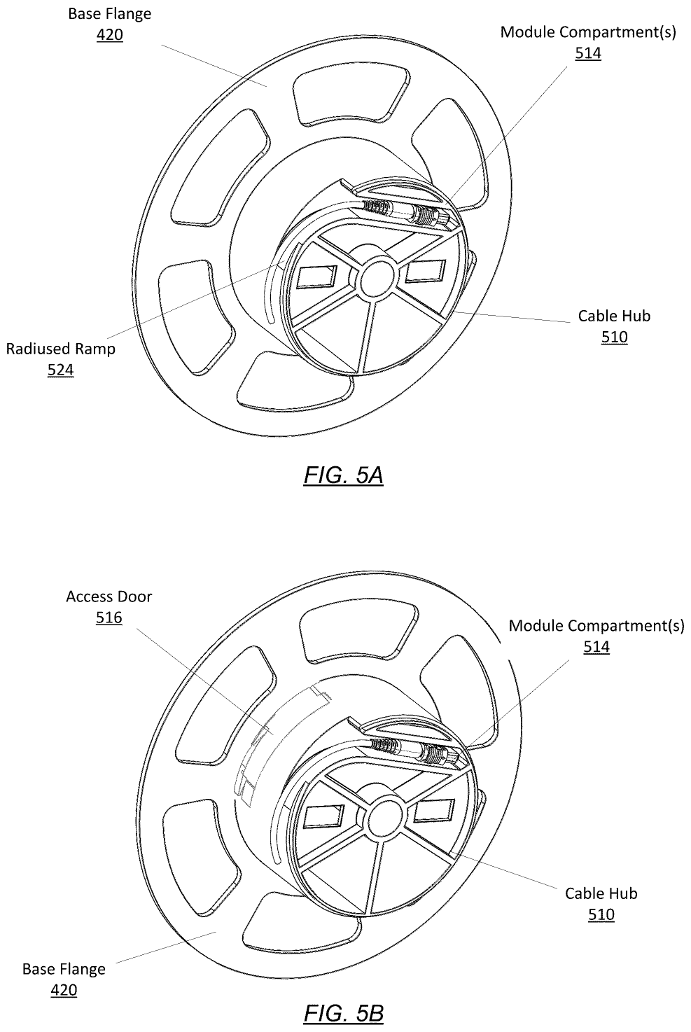

Referring now to FIGS. 5A and 5B, a single spool showing details of the cable hub is shown according to illustrative embodiments.

The cable hub (510) defines module compartments (514) configured to house one or more modules, such as adapter modules, which can be inserted into the hub. The compartments are accessible via an open pocket design, which eliminates the need for an access door. This open pocket design allows the end of the cable, including its connector, to be pulled straight out of the module compartments once cable payout has been completed, facilitating ease of use during deployment.

The cable hub (510) includes a radiused ramp (524) positioned at the exit of the module compartments (514). The radiused ramp transitions the cable from within the module compartments to the external surface of the cable hub, guiding the cable along a path that maintains its bend radius to reduce stress during routing. The ramp ensures smooth and organized cable payout, protecting the cable from damage during operation.

In FIG. 5B, the spool includes a base flange (420) and a cable hub (510). The cable hub defines module compartments (514) for housing one or more modules, such as adapter modules. An access door (516) is integrated into the hub and provides selective access to the module compartments, allowing for insertion, removal, or inspection of the modules. In addition, the cable hub incorporates an open connector pocket, enabling the end of the cable with its connector to be pulled straight out after cable payout has been completed.

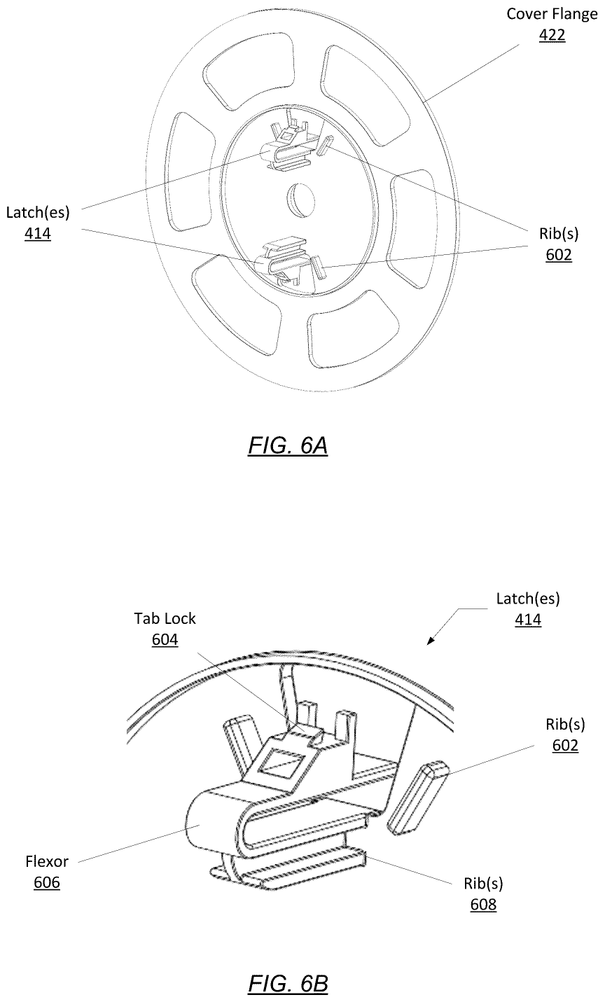

Referring now to FIGS. 6A and 6B, a cover flange is shown according to illustrative embodiments.

The cover flange (422) includes latch(es) (414) designed to interconnect the flange with other components of the spool assembly. The latches are supported by ribs (602), which provide structural reinforcement and prevent deformation during operation. These ribs extend radially from the central hub area toward the latches, distributing forces generated during engagement or disengagement.

In FIG. 6B a detailed view of the latch mechanism is shown. The latch(es) (414) is shown to include a tab lock (604) and a flexor (606). The tab lock secures the latch into a corresponding latch catch on an adjacent component, such as the base flange. The flexor (606) is designed to allow deflection of the latch during assembly or disassembly, enabling the tab lock (604) to engage or disengage without damage to the structural components. Additional ribs (608) are positioned around the latch mechanism to further enhance rigidity and ensure proper alignment during operation.

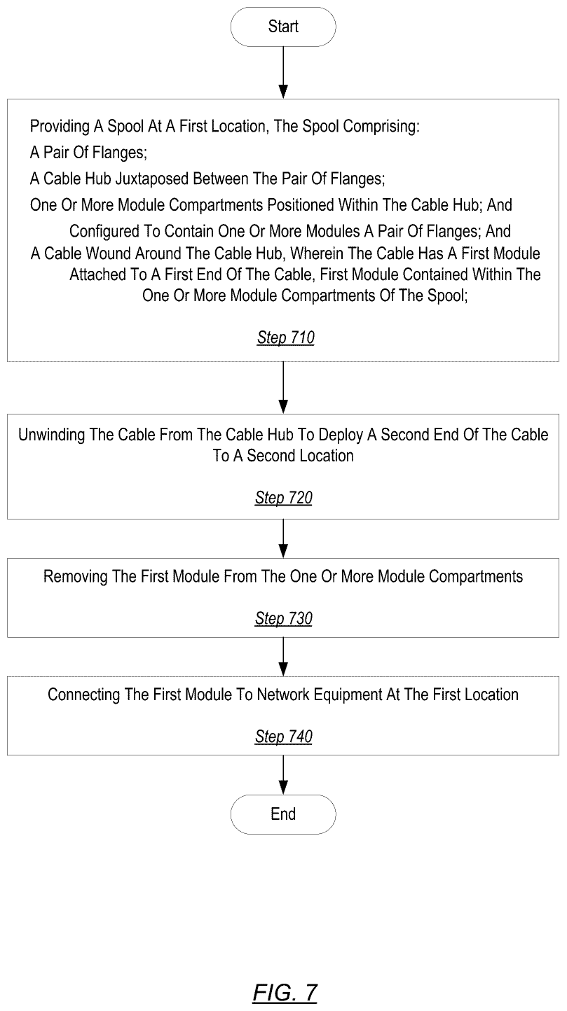

FIG. 7 is a method for deploying a cable, shown according to illustrative embodiments.

At step 710, a spool is provided at a first location. The first location may be a network installation site, data center, or another environment requiring structured cable deployment. The spool includes a pair of flanges, and a cable hub positioned between them, with one or more module compartments integrated within the hub. These module compartments are designed to house one or more modules, such as fiber optic adapter modules or other network interface components.

A cable is pre-wound around the cable hub, with a first end of the cable connected to a module that is secured within a module compartment. This configuration allows for controlled storage and deployment of the cable while ensuring that the module is protected within the spool before use. The spool may be placed on a stand that allows rotation during cable payout, and the flanges may include features such as spool locks, which can either enable independent rotation of each spool or synchronize multiple spools for co-rotation.

At step 720: the cable is unwound from the cable hub to deploy a second end of the cable to a second location. The cable is unwound from the cable hub to extend a second end of the cable to a second location, such as another equipment rack, a server, or a patch panel. During payout, the spool may rotate on its stand, with spacers reducing friction between adjacent spools if multiple spools are present.

At Step 730: the first module is removed from the one or more module compartments within the cable hub. This step involves opening an access door, if present, to retrieve the module. Alternatively, if the spool is configured with an open pocket design, the module may be pulled out without requiring access door manipulation.

The module may be designed to interface with network equipment at the first location, such as a switch, router, or fiber patch panel. If multiple modules are housed within the spool, additional modules may also be retrieved as needed.

At step 740, the first module is connected to network equipment at the first location. The module may serve as an interface between the deployed cable and active network components, providing connectivity for data transmission, signal routing, or power distribution.

The various descriptions of the figures may be combined and may include or be included within the features described in the other figures of the application. The various elements, systems, components, and steps shown in the figures may be omitted, repeated, combined, and/or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, “or” is an “inclusive or” and, as such includes “and.” Further, items joined by an or may include any combination of the items with any number of each item unless expressly stated otherwise.

The figures of the disclosure show diagrams of embodiments that are in accordance with the disclosure. The embodiments of the figures may be combined and may include or be included within the features and embodiments described in the other figures of the application. The features and elements of the figures are, individually and as a combination, improvements to the technology of keyword extraction using tags and n-grams. The various elements, systems, components, and steps shown in the figures may be omitted, repeated, combined, and/or altered as shown from the figures. Accordingly, the scope of the present disclosure should not be considered limited to the specific arrangements shown in the figures.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. An apparatus comprising:
a set of spools, each spool comprising:
a pair of flanges;
a cable hub juxtaposed between the pair of flanges; and
one or more module compartments positioned within the cable hub and configured to contain one or more modules.

2. The apparatus of claim 1, wherein at least one of the flanges comprises an access door that opens to the one or more module compartments.

3. The apparatus of claim 1, wherein the cable hub is elliptical in shape.

4. The apparatus of claim 1, wherein the cable hub further comprises:
an access door that opens to the one or more module compartments, wherein the access door has a radius of curvature along an outer surface that is about equal to a radius of curvature of the cable hub.

5. The apparatus of claim 1, wherein the cable hub further comprises:
a radius ramp exiting the one or more module compartments and connecting to an exterior of the cable hub along a transition curve.

6. The apparatus of claim 1, further comprising:
a first module contained within the cable hub of a spool in the one or more module compartments; and
a first cable connected to the first module at a first end of the first cable, wherein the first cable is routed out of the module compartments and wound around the cable hub.

7. The apparatus of claim 6, further comprising:
a second module contained within the cable hub of the spool in the one or more module compartments; and
a second cable connected to the second module at a first end of the second cable, wherein the second cable is routed out of the module compartments and coextensively wound around the cable hub with the first cable.

8. The apparatus of claim 1, wherein the cable hub is monolithic with at least one of the flanges.

9. The apparatus of claim 1, further comprising:
a stand, wherein the set of spools is rotatably mounted thereon; and
a set of spacers interposed between adjacent ones of the set of spools.

10. The apparatus of claim 8, wherein each spool is independently rotatable.

11. The apparatus of claim 8, wherein each flange further comprises:
a set of spool locks that rotatably secure together one or more spools of set of spools such that the set of spools corotate.

12. A method for deploying a cable, the method comprising:
providing a spool at a first location, the spool comprising:
a pair of flanges;
a cable hub juxtaposed between the pair of flanges;
one or more module compartments positioned within the cable hub; and
configured to contain one or more modules a pair of flanges; and
a cable wound around the cable hub, wherein the cable has a first module attached to a first end of the cable, first module contained within the one or more module compartments of the spool;
unwinding the cable from the cable hub to deploy a second end of the cable to a second location;
removing the first module from the one or more module compartments; and
connecting the first module to network equipment at the first location.

13. The method of claim 12, wherein the cable is routed through a radiused ramp exiting the module compartments within the cable hub.

14. The method of claim 12, wherein removing the first module from the one or more module compartments further comprises:
pulling the first module through a connector pocket opening to the one or more module compartments after unwinding the cable from the cable hub.

15. The method of claim 12, further comprising:
stabilizing the spool on a stand using spacers interposed between adjacent spools in a multi-spool configuration.

16. The method of claim 12, wherein unwinding the cable from the cable hub further comprising:
rotating the spool on a stand to facilitate unwinding the cable, wherein the spool is rotatably mounted on the stand.

17. The method of claim 16, further comprising:
unwinding cables from multiple spools on the stand simultaneously, wherein the spools are independently rotatable.

18. The method of claim 16, wherein the spool is a first spool, the method further comprising:
engaging a spool lock to allow co-rotation of multiple spools during deployment.

19. A multi-spool cable reel comprising:
a set of spools, each spool comprising:
a pair of flanges;
a cable hub juxtaposed between the pair of flanges; and
one or more module compartments positioned within the cable hub and configured to contain one or more modules.

20. The multi-spool cable reel of claim 19, further comprising:
a stand, wherein the set of spools is rotatably mounted thereon; and
a set of spacers interposed between adjacent ones of the set of spools.
